(19) United States
(12) Patent Application Publication
(10) Pub. No.: US 2012/0128188 A1
(43) Pub. Date: May 24, 2012

(54) HEARING AID

(75) Inventors: PhanHow Amy Cheng, Singapore (SG); Peilin Phui, Singapore (SG); Wee Hiong Tan, Singapore (SG)

(73) Assignee: SIEMENS MEDICAL INSTRUMENTS PTE. LTD., SINGAPORE (SG)

(21) Appl. No.: 13/125,883

(22) PCT Filed: Oct. 23, 2008
(86) PCT No.: PCT/SG08/00410

§ 371 Date: May 18, 2011

(51) Int. Cl. H04R 25/00

(52) U.S. Cl. 381/323

(57) ABSTRACT

A hearing aid includes a hearing aid housing and a battery chamber housing coupled to the hearing aid housing and configured to receive a battery. A first charging pin is configured to be electrically connected to the battery to be received in the battery chamber housing and the first charging pin is configured to connect the hearing aid housing to the battery. A first protective cover is positioned over the first charging pin in such a way that the first protective cover is in physical contact with the hearing aid housing.

Embodiments relate to a hearing aid.

A hearing aid is usually fitted in or behind the ear of the user to amplify the sound for the user. Some popular types of hearing aids include behind-the-ear (BTE) aids, in the ear (ITE) aids, in the canal (ITC) aids, completely in the canal (CIC) aids, etc.

The hearing aid usually includes a hearing aid housing within which a microphone for collecting sound waves, a signal processing circuit (also referred to as a speech processing circuit) for processing the collected sound waves and a loudspeaker (which may also be referred to as a receiver in the field of hearing aids) may be housed. To provide power for the microphone, the signal processing circuit and the loudspeaker, the hearing aid usually includes a battery chamber housing, also referred to as a battery door, coupled to the hearing aid housing to receive a battery. In addition, for charging of the battery, the hearing aid usually includes charging pins.

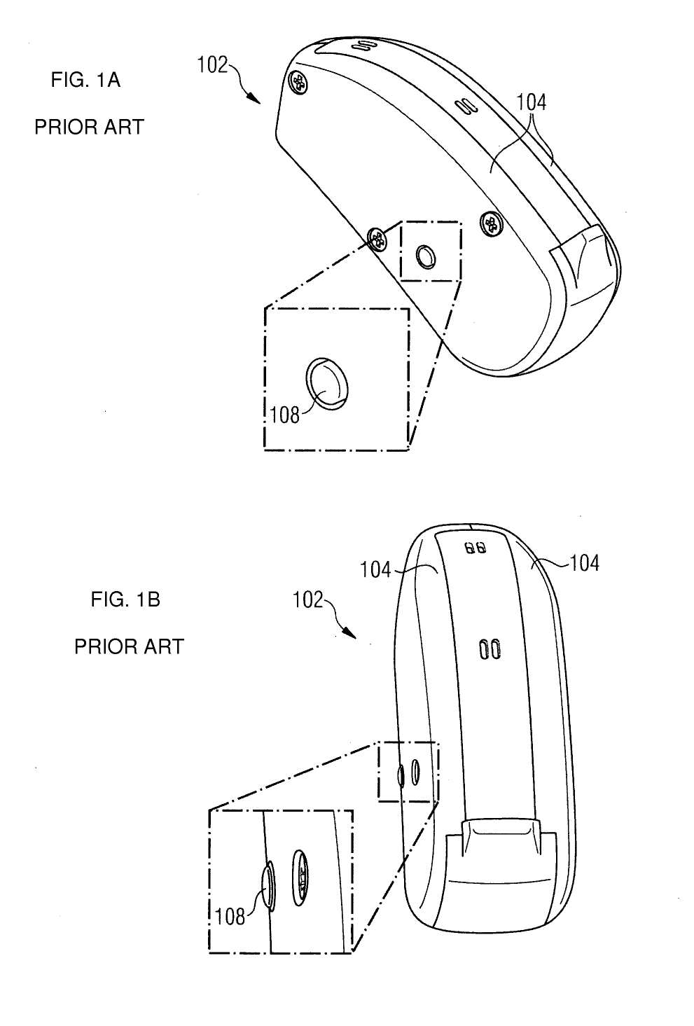

FIG. 1A and FIG. 1B show a respective perspective view and side view of a conventional behind-the-ear (BTE) hearing aid 102. The hearing aid 102 may include a hearing aid housing 104, a battery chamber housing (not shown) coupled to the hearing aid housing 104 and two charging pins 108, 110 (only the first charging pin 108 is shown in FIG. 1A and FIG. 1B in respective enlarged views) for charging the battery (not shown) housed within the battery chamber housing.

The hearing aid housing 104 may accommodate a microphone, a signal processing circuit and a loudspeaker. The battery chamber housing may be pivoted into or out of the hearing aid housing 104. The battery chamber housing may receive a battery used for driving the hearing aid 102.

Each of the two charging pins 108, 110 may be exposed after being assembled into the BTE hearing aid 102. Therefore, each of the two charging pins 108, 110 may be in direct contact with the skin of a hearing aid user, resulting in a likely deposition of dirt and a likely electrical contact with the hearing aid user. Therefore, it may be desired to prevent physical contact of each of the two charging pins 108, 110 with the skin of the hearing aid user.

In various embodiments, a hearing aid may be provided, which may include a protective cover for each charging pin which may prevent direct contact of the charging pin with the hearing aid user.

An embodiment relates to a hearing aid. The hearing aid may include a hearing aid housing; a battery chamber housing coupled to the hearing aid housing, the battery chamber housing configured to receive a battery; a first charging pin configured to electrically connect the hearing aid housing to the battery to be received in the battery chamber housing; and a first protective cover positioned over the first charging pin, wherein the first protective cover may be in physical contact with the hearing aid housing.

In an embodiment, the hearing aid may further include a second charging pin configured to electrically connect the hearing aid housing to the battery to be received in the battery chamber housing.

In an embodiment, each of the first charging pin and the second charging pin may include an electrical conductive material, for example stainless steel.

In an embodiment, the hearing aid may further include a second protective cover positioned over the second charging pin, wherein the second protective cover may be in physical contact with the hearing aid housing.

In one embodiment, each of the first charging pin and the second charging pin may include a first end and a second end. The first end may be coupled to a charger for charging the battery and the second end may be coupled to the battery. In this regard, the second end may be termed a battery contact as the second end may be in direct contact with the battery.

In an embodiment, the hearing aid housing may include a first hearing aid housing portion and a second hearing aid housing portion.

In an embodiment, the first hearing aid housing portion may be complementary in shape to the second hearing aid housing portion. The first hearing aid housing portion and the second hearing aid housing portion may be of any suitable shape depending on requirement.

In an embodiment, the first hearing aid housing portion may be positioned opposite to the second hearing aid housing portion. The first hearing aid housing portion may be configured to be fitted to the second hearing aid housing portion via any suitable means. By way of example, the first hearing aid housing portion may be snap-fitted onto the second hearing aid housing portion.

In an embodiment, the first protective cover may be in physical contact with the first hearing aid housing portion and the second protective cover may be in physical contact with the second hearing aid housing portion. The first protective cover may be positioned such that the first protective cover may be biased against the first hearing aid housing portion to hold the first charging pin in place. Similarly, the second protective cover may be positioned such that the second protective cover may be biased against the second hearing aid housing portion to hold the second charging pin in place.

In an embodiment, the first protective cover may be configured to accommodate the first charging pin such that the first charging pin may not be in direct contact with a user.

In an embodiment, the first protective cover may be configured to protrude externally from the first hearing aid housing portion such that the first charging pin may not be in direct contact with the user. Instead, the first protective cover may be in contact with the user. The extent of the protrusion of the first protective cover may vary and depends on design requirements.

In an embodiment, the first protective cover may include a material selected from a group consisting of an insulating material, a bio-compatible material, a flexible material. The first protective material may include any material which may prevent the first charging pin from causing any electrical shock to the user.

In an embodiment, the first protective cover may include a rubber material or any other suitable materials.

In an embodiment, the second protective cover may be configured to accommodate the second charging pin such that the second charging pin may not be in direct contact with a user.

In an embodiment, the second protective cover may be configured to protrude externally from the second hearing aid housing portion such that the second charging pin may not be in direct contact with the user. Instead, the second protective cover may be in contact with the user. The extent of the protrusion of the second protective cover may vary and depends on design requirements.

In an embodiment, the second protective cover may include a material selected from a group consisting of an insulating material, a bio-compatible material, a flexible material. The second protective material may include any material which may prevent the second charging pin from causing any electrical contact to the user.

In an embodiment, the second protective cover may include a rubber material or any other suitable materials.

In an embodiment, each of the first protective cover and the second protective cover may include an opening which may be surrounded by a plurality of flaps. Each of the plurality of flaps may be configured to flex apart so as to accommodate the respective fitting of the first charging pin and the second charging pin.

In an embodiment, the first protective cover may be the same as the second protective cover.

In an embodiment, the hearing aid may be a behind-the-ear hearing aid.

In an embodiment, the hearing aid housing may be configured to receive the battery chamber housing. For example, the battery chamber housing may be used to house a battery to provide power for the microphone, signal processing circuit, loudspeaker, and other suitable components or circuits in the hearing aid, etc.

In an embodiment, the battery chamber housing may be pivotally mounted or mounted via any suitable means on the hearing aid housing. The battery chamber housing may also include a notch for ease of opening and closing the battery chamber housing. For example, the battery chamber housing may be pivoted out of the hearing aid housing to put in or to take out a battery in the battery chamber housing, and may then be pivoted back into the hearing aid housing.

In an embodiment, the battery chamber housing may include a partially circular outer shape so as to accommodate a circular battery. The shape of the battery chamber housing may correspond with the shape of the battery so as to fix the battery within the hearing aid housing when the battery chamber housing may be closed. The battery chamber housing may include any other suitable shapes depending on design requirements.

In an embodiment, the hearing aid housing may include a plastic material or any other suitable material.

In an embodiment, the battery chamber housing may include a plastic material or any other suitable material.

In an embodiment, the hearing aid housing may be of the same material as the battery chamber housing. Use of the same material for both the hearing aid housing and the battery chamber housing may provide for ease of fabrication for the hearing aid housing and the battery chamber housing.

In an embodiment, the first charging pin and the second charging pin are respectively inserted into the first protective cover and the second protective cover before being assembled into the hearing aid housing. In this regard, the first protective cover and the second protective cover respectively protrude externally from the first hearing aid housing portion and the second hearing aid housing portion but not the first charging pin and the second charging pin. In this regard, the first charging pin and the second charging pin may be considered to be concealed or may not be directly in contact with a hearing aid user, in particular not with the skin of a hearing aid user.

In an embodiment, when the hearing aid is placed in the charger, the corresponding charging contacts from the charger may respectively be inserted into the first protective cover and the second protective cover to physically contact the first charging pin and the second charging pin to recharge the battery.

In an embodiment, the introduction of the first protective cover and the second protective cover may prevent any direct contact of the first charging pin and the second charging pin with the hearing aid user's skin. The respective first and second protective covers may also help to minimize direct contact of the hearing aid user's perspiration with the respective first and second charging pins. Further, the respective first and second protective covers may prevent the deposition of dirt on the respective first and second charging pins.

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A and FIG. 1B show respective perspective view and side view of a conventional behind-the-ear hearing aid;

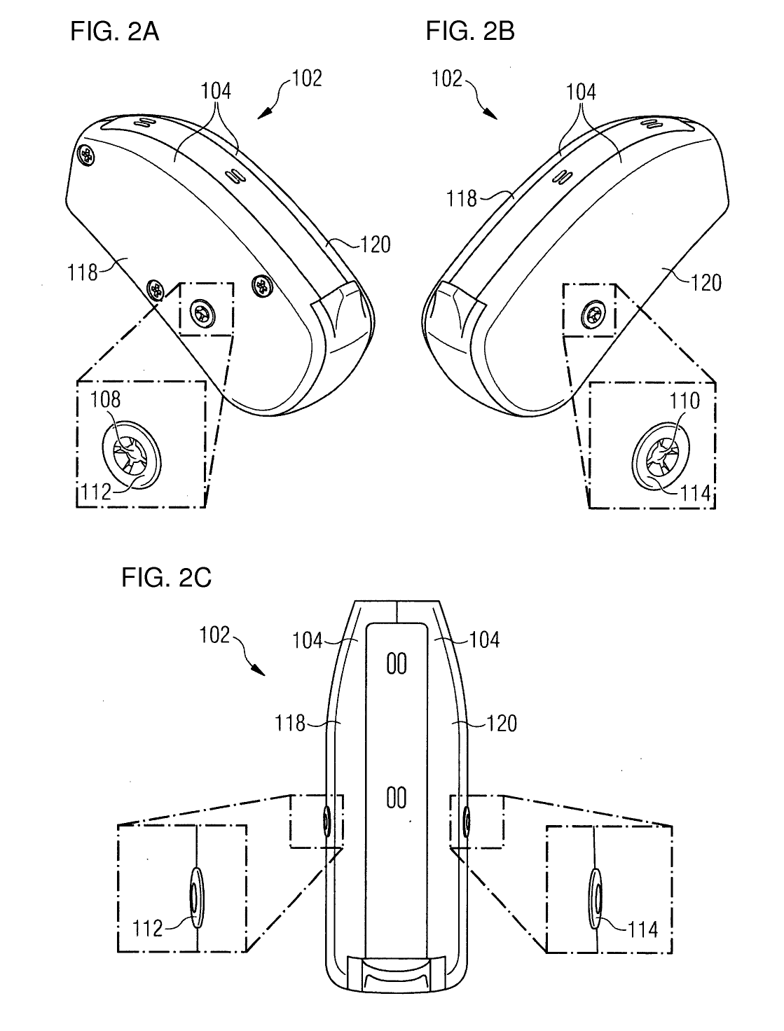

FIG. 2A, FIG. 2B and FIG. 2C show respective left perspective view, right perspective view and side view of a hearing aid according to an embodiment;

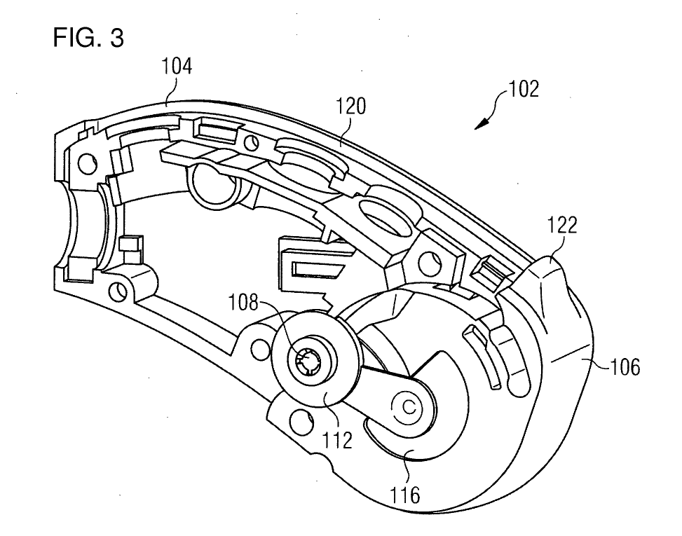

FIG. 3 shows an internal view of the hearing aid of FIG. 2B (with the first hearing aid housing portion removed) according to an embodiment; and

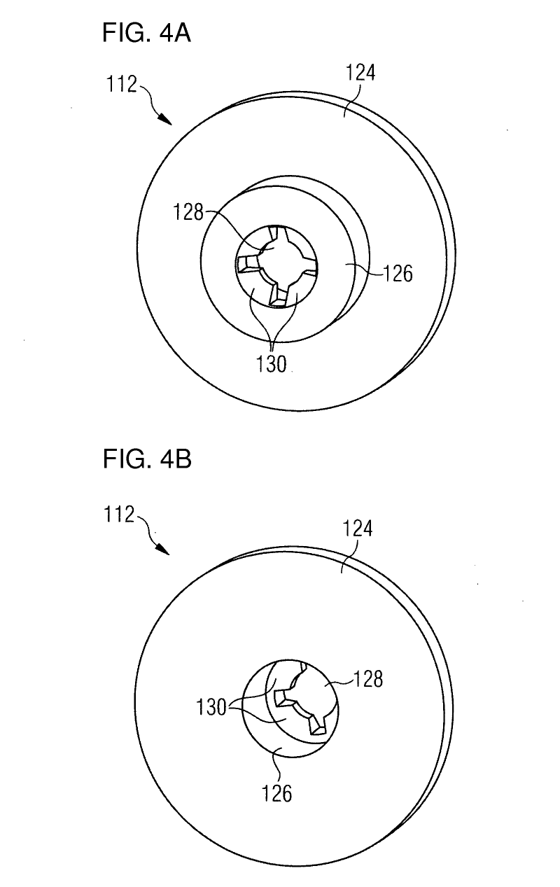

FIG. 4A and FIG. 4B show respective front view and back view of a first protective cover according to an embodiment.

FIG. 2A and FIG. 2B show respective perspective view and side view of a hearing aid 102 according to an embodiment.

By way of example, FIG. 2A, FIG. 2B and FIG. 2C show a behind-the-ear hearing aid 102. The hearing aid 102 may include a hearing aid housing 104, a battery chamber housing (not shown) coupled to the hearing aid housing 104, the battery chamber housing configured to receive a battery (not shown). The hearing aid 102 may further include a first charging pin 108 configured to electrically connect the hearing aid housing 104 to the battery to be received in the battery chamber housing and a first protective cover 112 positioned over the first charging pin 108, wherein the first protective cover 112 may be in physical contact with the hearing aid housing 104.

The hearing aid 102 may further include a second charging pin 110 configured to electrically connect the hearing aid housing 104 to the battery to be received in the battery chamber housing and a second protective cover 114 positioned over the second charging pin 110, wherein the second protective cover 114 may be in physical contact with the hearing aid housing 104.

The hearing aid housing 104 may include a first hearing aid housing portion 118 and a second hearing aid housing portion 120. The first hearing aid housing portion 118 may be complementary in shape to the second hearing aid housing portion 120. The first hearing aid housing portion 118 may be positioned opposite to the second hearing aid housing portion 120.

The first protective cover 112 may be in physical contact with the first hearing aid housing portion 118 and the second protective cover 114 may be in physical contact with the second hearing aid housing portion 120.

The first protective cover 112 may be configured to accommodate the first charging pin 108 such that the first charging pin 108 may not be in direct contact with a user, in particular with a user's skin. The first protective cover 112 may be configured to protrude externally from the first hearing aid housing portion 118. The first protective cover 112 may include a material selected from a group consisting of an insulating material, a bio-compatible material, a flexible material. The first protective cover 112 may include a rubber material or any other suitable materials.

The second protective cover 114 may be configured to accommodate the second charging pin 110 such that the second charging pin 110 may not be in direct contact with a user. The second protective cover 114 may be configured to protrude externally from the second hearing aid housing portion 120. The second protective cover 114 may include a material selected from a group consisting of an insulating material, a bio-compatible material, a flexible material. The second protective cover 114 may include a rubber material or any suitable materials.

The hearing aid housing 104 may include a plastic material or any other suitable materials.

FIG. 3 shows an internal view of the hearing aid 102 of FIG. 2B (with the first hearing aid housing portion 118 removed) according to an embodiment.

By way of example, FIG. 3 shows a behind-the-ear hearing aid 102. The hearing aid 102 may include a hearing aid housing 104, a battery chamber housing 106 coupled to the hearing aid housing 104 (only a part of the hearing aid housing is shown), the battery chamber housing 106 configured to receive a battery 116. The hearing aid 102 may further include a first charging pin 108 configured to electrically connect the hearing aid housing 104 to the battery 116 to be received in the battery chamber housing 106 and a first protective cover 112 positioned over the first charging pin 108, wherein the first protective cover 112 may be in physical contact with the hearing aid housing 104.

The hearing aid 102 may further include a second charging pin (not shown) configured to electrically connect the hearing aid housing 104 to the battery 116 to be received in the battery chamber housing 106 and a second protective cover (not shown) positioned over the second charging pin, wherein the second protective cover may be in physical contact with the hearing aid housing 104.

The hearing aid housing 104 may include a first hearing aid housing portion (not shown) and a second hearing aid housing portion 120. The first hearing aid housing portion may be complementary in shape to the second hearing aid housing portion 120. The first hearing aid housing portion may be positioned opposite to the second hearing aid housing portion 120.

The first protective cover 112 may be in physical contact with the first hearing aid housing portion and the second protective cover may be in physical contact with the second hearing aid housing portion 120.

The first protective cover 112 may be configured to accommodate the first charging pin 108 such that the first charging pin 108 may not be in direct contact with a user. The first protective cover 112 may be configured to protrude externally from the first hearing aid housing portion. The first protective cover 112 may include a material selected from a group consisting of an insulating material, a bio-compatible material, a flexible material. The first protective cover 112 may include a rubber material.

The second protective cover may be configured to accommodate the second charging pin such that the second charging pin may not be in direct contact with a user, in particular with a user's skin. The second protective cover may be configured to protrude externally from the second hearing aid housing portion 120. The second protective cover may include a material selected from a group consisting of an insulating material, a bio-compatible material, a flexible material. The second protective cover may include a rubber material.

The hearing aid housing 104 may be configured to receive the battery chamber housing 106. The battery chamber housing 106 may be pivotally mounted on the hearing aid housing 104. The battery chamber housing 106 may include a partially circular outer shape, so as to accommodate the battery 116. The battery chamber housing 106 may include an opening portion 122 for ease of pivoting the battery chamber housing 106 into and out of the hearing aid housing 104. The opening portion 122 may be a protrusion and may be of any suitable shape.

The hearing aid housing 104 may include a plastic material and the battery chamber housing 106 may include a plastic material. The hearing aid housing 104 and the battery chamber housing 106 may be of any suitable material. The hearing aid housing 104 may be of the same material as the battery chamber housing 106.

FIG. 4A and FIG. 4B show respective front view and back view of a first protective cover 112 according to an embodiment.

The first protective cover 112 may be the same as the second protective cover 114. The first protective cover 112 may include an outer region 124 having a substantially circular shape and an inner region 126 having a corresponding circular shape. The outer region 124 and the inner region 126 may include other suitable shapes depending on design requirements.

As can be gathered from the front view in FIG. 4A, the inner region 126 may be seen as a protrusion and when seen from the back view in FIG. 4B, the inner region 126 may be seen as a recess. The protrusion may have a depth of about 1 mm.

The first protective cover 112 may include an opening 128 within the inner region 126, the opening 128 being surrounded by four spaced-apart flaps 130. Each of the flaps 130 may be of a similar dimension and may allow for the accommodation of the first charging pin 108 prior to assembling on the hearing aid housing (not shown). The opening 128 within the inner region 126 may be of a corresponding circular shape like the inner region 126 or may include any other suitable shapes.

The first protective cover 112 may be configured to accommodate the first charging pin (not shown) such that the first charging pin may not be in direct contact with a user. The first protective cover 112 may be configured to protrude externally from the first hearing aid housing portion 118. The first protective cover 112 may include a material selected from a group consisting of an insulating material, a bio-compatible material, a flexible material. The first protective cover 112 may include a rubber material.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-24. (canceled)

25. A hearing aid, comprising:
a hearing aid housing;
a battery chamber housing coupled to said hearing aid housing, said battery chamber housing configured to receive a battery;
a first charging pin configured to be electrically connected to the battery to be received in said battery chamber housing; and
a first protective cover positioned over said first charging pin, said first protective cover being in physical contact with said hearing aid housing.

26. The hearing aid according to claim 25, wherein said first charging pin is configured to connect said hearing aid housing to the battery to be received in said battery chamber housing.

27. The hearing aid according to claim 26, which further comprises a second charging pin configured to be electrically connected to the battery to be received in said battery chamber housing.

28. The hearing aid according to claim 27, wherein said second charging pin is configured to connect said hearing aid housing to the battery to be received in said battery chamber housing.

29. The hearing aid according to claim 28, which further comprises a second protective cover positioned over said second charging pin, said second protective cover being in physical contact with said hearing aid housing.

30. The hearing aid according to claim 25, wherein said hearing aid housing includes a first hearing aid housing portion and a second hearing aid housing portion.

31. The hearing aid according to claim 30, wherein said first hearing aid housing portion is complementary in shape to said second hearing aid housing portion.

32. The hearing aid according to claim 30, wherein said first hearing aid housing portion is positioned opposite to said second hearing aid housing portion.

33. The hearing aid according to claim 30, wherein said first protective cover is in physical contact with said first hearing aid housing portion and said second protective cover is in physical contact with said second hearing aid housing portion.

34. The hearing aid according to claim 25, wherein said first protective cover is configured to accommodate said first charging pin such that said first charging pin is not in direct contact with a user.

35. The hearing aid according to claim 30, wherein said first protective cover is configured to protrude externally from said first hearing aid housing portion.

36. The hearing aid according to claim 25, wherein said first protective cover is formed of a material selected from the group consisting of an insulating material, a bio-compatible material and a flexible material.

37. The hearing aid according to claim 25, wherein said first protective cover is formed of a rubber material.

38. The hearing aid according to claim 29, wherein said second protective cover is configured to accommodate said second charging pin such that said second charging pin is not in direct contact with a user.

39. The hearing aid according to claim 29, wherein said hearing aid housing includes a first hearing aid housing portion and a second hearing aid housing portion, and said second protective cover is configured to protrude externally from said second hearing aid housing portion.

40. The hearing aid according to claim 29, wherein said second protective cover is formed of a material selected from the group consisting of an insulating material, a bio-compatible material and a flexible material.

41. The hearing aid according to claim 29, wherein said second protective cover is formed of a rubber material.

42. The hearing aid according to claim 25, wherein the hearing aid is a behind-the-ear hearing aid.

43. The hearing aid according to claim 25, wherein said hearing aid housing is configured to receive said battery chamber housing.

44. The hearing aid according to claim 25, wherein said battery chamber housing is pivotally mounted on said hearing aid housing.

45. The hearing aid according to claim 25, wherein said battery chamber housing has a partially circular outer shape.

46. The hearing aid according to claim 25, wherein said hearing aid housing is formed of a plastic material.

47. The hearing aid according to claim 25, wherein said battery chamber housing is formed of a plastic material.

48. The hearing aid according to claim 25, wherein said hearing aid housing and said battery chamber housing are formed of the same material.
